(19) United States
(12) Patent Application Publication
(10) Pub. No.: US 2023/0115618 A1
(43) Pub. Date: Apr. 13, 2023

(54) Gas-Separation Membranes

(71) Applicants: Fujifilm Manufacturing Europe B.V., Tilburg (NL); Fujifilm Corporation, Tokyo (JP)

(72) Inventors: Shigehide Itoh, Tilburg (NL); Gerardus Maria Bogels, Tilburg (NL)

(21) Appl. No.: 17/905,272

(22) PCT Filed: Mar. 23, 2021
(86) PCT No.: PCT/EP2021/057348

§ 371 Date: Aug. 30, 2022

(30) Foreign Application Priority Data
Apr. 1, 2020 (GB) 2004794.0

(51) Int. Cl. B01D 67/00; B01D 69/02; B01D 71/80

(52) U.S. Cl. CPC B01D 67/0011; B01D 69/02; B01D 71/80; B01D 67/0006; B01D 67/009; B01D 2325/20; B01D 2257/304; B01D 2256/245; B01D 2258/0283

(57) ABSTRACT

A gas-separation membrane obtainable from curing a composition comprising one or more curable monomers at least 30 wt % of which are monomer(s) comprising oxyethylene groups, oxypropylene groups and at least two polymerizable groups.

This invention relates to gas-separation membranes and to their preparation and use.

For purifying gaseous mixtures e.g. natural gas and flue gas, the removal of undesired components can in some cases be achieved based on the relative size of the components (size-sieving).

U.S. Pat. No. 8,177,891 describes gas-separation membranes comprising a continuous substantially non-porous layer comprising the polymerization product of a compound, which compound comprises at least 70 oxyethylene groups forming an uninterrupted chain of the formula —(CH₂CH₂O)ₙ— wherein n is at least 70.

U.S. Pat. No. 8,303,691 describes composite membranes comprising a polymer sheet and a porous support layer for the polymer sheet, CHARACTERISED IN THAT the polymer sheet comprises at least 60 wt % of oxyethylene groups and the porous support layer has defined flux properties.

There is a need for strong, flexible gas-separation membranes having a high permeability and being capable of discriminating well between gases (e.g. between polar and non-polar gases). Ideally such membranes can be produced efficiently at high speeds using toxicologically acceptable liquids (particularly water). In this manner the membranes could be made in a particularly cost effective manner.

According to a first aspect of the present invention there is provided a gas-separation membrane obtainable from a process comprising curing a composition comprising one or more curable monomer(s) of which at least 30 wt % are monomer(s) comprising oxyethylene groups, oxypropylene groups and at least two polymerizable groups.

In this specification the term “comprising” is to be interpreted as specifying the presence of the stated parts, steps or components, but does not exclude the presence of one or more additional parts, steps or components.

Reference to an element by the indefinite article “a” or “an” does not exclude the possibility that more than one of the element(s) is present, unless the context clearly requires that there be one and only one of the elements. The indefinite article “a” or “an” thus usually means “at least one”.

The term “NAMW” as used in this specification means number average molecular weight. The NAMW values described in this specification are preferably as measured by size exclusion chromatography.

For brevity, in this specification a curable monomer comprising oxyethylene groups (“EO groups”), oxypropylene groups (“PO groups”) and at least two polymerizable groups is often abbreviated herein to the “EO-PO monomer”.

The purpose of the EO-PO monomer is to form a membrane which discriminates between gasses, allowing some gases to permeate through faster than others.

Preferably the oxyethylene groups and the oxypropylene groups present in the EO-PO monomer are distributed randomly therein. For example, the oxyethylene groups and the oxypropylene groups form a linear chain which is terminated by a polymerizable group at each end and the oxyethylene groups and the oxypropylene groups are distributed randomly along said chain. This preference arises because it improves the properties of the resultant gas-separation membrane, making the membrane less likely to degrade on contact with liquids and vapors.

Preferably the number of oxyethylene groups in the EO-PO monomer is greater than the number of oxypropylene groups present in the EO-PO monomer, e.g. by a factor of 2 or more. For example, the number of oxyethylene groups present in EO-PO monomer is a factor of 4 to 5 times the number of oxypropylene groups present in the EO-PO monomer. These preferences arise because they can provide the resultant gas-separation membrane with good permeability to polar gases such that polar gases pass through the membrane much more readily than non-polar gases.

Preferably the EO-PO monomer comprises from 5 to 100 oxyethylene groups, more preferably from 10 to 60 oxyethylene groups.

Preferably the EO-PO monomer comprises from 2 to 30 oxypropylene groups, more preferably from 4 to 20 oxypropylene groups.

In a preferred embodiment the wt % of oxypropylene groups in the EO-PO monomer is from 10 wt % to 60 wt %, more preferably from 20 to 45 wt %. The wt % of oxyethylene groups in the EO-PO monomer is preferably from 50 to 90 wt %, especially 60 to 80 wt %.

Preferably the EO-PO monomer has a NAMW of 500 to 5,000. The NAMW of the EO-PO monomer may be measured by Gel Permeation Chromatography.

The monomer comprising oxyethylene groups, oxypropylene groups and at least two polymerizable groups is preferably of Formula (1):

H₂C═CH—CO₂-L-CO—CH═CH₂ Formula (1)

wherein L is a divalent organic linking group comprising oxypropylene groups and oxyethylene groups.

The divalent organic linking group represented by L preferably comprises 4 to 20 of the oxypropylene groups and 10 to 60 of the oxyethylene groups.

In Formula (1) the “—CO—” group is part of an ester group with the remaining oxygen atom of that ester group being at the nearest end of the group represented by L.

Preferably the oxypropylene groups and the oxyethylene groups are distributed randomly in the divalent organic linking group represented by L.

The oxypropylene groups are preferably of the formula —CH₂CH(CH₃)O—.

The oxyethylene groups are of the formula —CH₂CH₂O—

Examples of commercially available EO-PO monomers include NK ECONOMER™ A-1000 PER (Mn of 1,106, 17 oxyethylene groups and 4 oxypropylene groups) and NK ECONOMER™ A-3000 PER (Mn of 3,124, 51 oxyethylene groups and 13 oxypropylene groups). ECONOMER™ A-1000 PER and A-3000 PER are available from Shin-Nakamura Chemical Co., Ltd).

In one embodiment all of the curable monomers present in the composition are EO-PO monomers. In another embodiment, the curable monomers comprise one or more EO-PO monomers and one or more further monomers which are not EO-PO monomers, provided that at least 30 wt % (preferably at least 50 wt %) of all curable monomers present in the composition are EO-PO monomers.

The composition optionally contains one or more than one EO-PO monomer.

The total amount of EO-PO monomer(s) present in the composition is preferably 20 to 90 wt %, more preferably 30 to 90 wt %, especially 40 to 80 wt %, relative to the total weight of the composition.

Optionally the composition further comprises one or more further monomers in addition to the EO-PO monomer. Such additional monomer(s) are curable and comprise at least one polymerizable group (e.g. one, two or three polymerizable groups, especially two polymerizable groups) and being free from oxypropylene groups. The further monomer comprises at least one polymerizable group and being free from oxypropylene groups is herein abbreviated to the “the further monomer”.

The further monomer preferably comprises oxyethylene groups (e.g. 2 to 1,000 oxyethylene groups, especially 10 to 250 oxyethylene groups, e.g. 10, 15, 20, 135 or 230 oxyethylene groups). The further monomer preferably has a NAMW of from 200 to 25,000, more preferably from 400 to 15,000, especially from 600 to 10,000 g/mol.

Examples of further monomers include poly(ethylene glycol) diacrylate, bisphenol A ethoxylate diacrylate, neopentyl glycol ethoxylate diacrylate, propanediol ethoxylate diacrylate, butanediol ethoxylate diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate and combinations of two or more thereof. The amount of further monomer present in the composition is preferably 1 to 65 wt %, more preferably 10 to 60 wt %, especially 20 to 50 wt %, relative to the total weight of the composition. In any case, the amount of further monomers, relative to the total weight of curable monomers present in the composition, does not exceed 69 wt %.

Optionally the composition further comprises an initiator, e.g. a thermal initiator and/or a photo-initiator.

Examples of thermal initiators include organic peroxides, for example ethyl peroxide and benzyl peroxide; hydroperoxides, e.g. methyl hydroperoxide; acyloins, e.g. benzoin; certain azo compounds, e.g. α,α′-azobisisobutyronitrile and γ,γ′-azobis(γ-cyanovaleric acid); persulfates; peracetates, e.g. methyl peracetate and tert-butyl peracetate; peroxalates, e.g. dimethyl peroxalate and di(tert-butyl) peroxalate; disulfides, e.g. dimethyl thiuram disulfide; and ketone peroxides, e.g. methyl ethyl ketone peroxide. When the composition comprises a thermal initiator curing is preferably performed at a temperature in the range of from about 30° C. to about 150° C., especially from about 40° C. to about 110° C.

Photo-initiators are usually required when the curing uses light, for example ultraviolet (“UV”) radiation. Suitable photo-initiators are those known in the art such as radical-type, cation is photo-initiators and anionic photo-initiators.

Cationic photo-initiators are preferred when the EO-PO monomer comprises curable groups such as epoxy, oxetane, other ring-opening heterocyclic groups or vinyl ether groups.

Preferred cationic photo-initiators include organic salts of non-nucleophilic anions, e.g. hexafluoroarsinate anion, antimony (V) hexafluoride anion, phosphorus hexafluoride anion, tetrafluoroborate anion and tetrakis(2,3,4,5,6-pentafluorophenyl) boranide anion. Commercially available cationic photo-initiators include UV-9380c, UV-9390c (manufactured by Momentive performance materials), UVI-6974, UVI-6970, UVI-6990 (manufactured by Union Carbide Corp.), CD-1010, CD-1011, CD-1012 (manufactured by Sartomer Corp.), Adekaoptomer™ SP-150, SP-151, SP-170, SP-171 (manufactured by Asahi Denka Kogyo Co., Ltd.), Irgacure™ 250, Irgacure™ 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103 and BBI-103 (Midori Chemical Co., Ltd.). The above mentioned cationic photo-initiators can be used either individually or in combination of two or more.

Radical Type I and/or type II photo-initiators may also be used when the EO-PO monomer comprises an ethylenically unsaturated group, e.g. a (meth)acrylate or (meth)acrylamide.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto.

The amount of photo-initiator present in the composition is preferably 0.005 to 2 wt %, more preferably 0.01 to 1 wt %.

A single type of photo-initiator may be used but also a combination of several different types.

When no photo-initiator is included in the composition, the composition can be advantageously cured by electron-beam exposure. Preferably the electron beam output is between 50 and 300 keV. Curing can also be achieved by plasma or corona exposure.

The amount of initiator present in the composition is preferably 0.01 to 10 wt %, more preferably 0.05 to 5 wt %, especially 0.1 to 1 wt %, relative to the total weight of the composition.

In a preferred embodiment the composition further comprises an inert solvent. The inert solvent is particularly useful for providing the composition with a viscosity suitable for applying the composition to a porous support. For high speed application processes one will usually choose an inert solvent of low viscosity. Examples of suitable inert solvents are mentioned above in relation to preparation of the PCP Polymer.

Inert solvents are not radiation-curable.

The inert solvent optionally comprises a single inert solvent or a combination of two or more inert solvents. Preferred inert solvents include water, C₁₋₄ alcohols (e.g. methanol, ethanol and propan-2-ol), diols (e.g. ethylene glycol and propylene glycol), triols (e.g. glycerol), carbonates (e.g. ethylene carbonate, propylene carbonate, dimethyl carbonate, diethyl carbonate, di-t-butyl dicarbonate and glycerin carbonate), dimethyl formamide, acetone, N-methyl-2-pyrrolidinone and mixtures comprising two or more thereof. A particularly preferred inert solvent is ethyl acetate. In one embodiment the inert solvent has a low boiling point e.g. a boiling point below 100° C. Solvents having a low boiling point can be easily removed after curing by evaporation, avoiding the need for a washing step for removal of the solvent.

Being inert, the solvent does not co-polymerise with any of the other components of the curable composition.

The amount of inert solvent present in the radiation-curable composition is preferably 40 to 99 wt %, more preferably 50 to 90 wt %, relative to the total weight of the composition.

In view of the foregoing, the composition preferably comprises:

(a) from 30 to 90 wt %, especially 40 to 80 wt %, of EO-PO monomer(s);
(b) from 10 to 60 wt %, especially 20 to 50 wt %, of the further monomer(s);
(c) from 0.05 to 5 wt %, especially 0.1 to 1 wt %, of initiator; and
(d) from 40 to 99 wt %, especially 50 to 90 wt %, of inert solvent;
provided that the amount of component (a) is at least 30 wt % relative to the total weight of components [(a)+(b)] present in the composition.

Preferably the amount of (a)+(b)+(c)+(d) adds up to 100%. This does not exclude the presence of other components other that (a), (b), (c) and (d) but it sets the total amount of these four components. In one embodiment the composition consists solely of components (a) to (d) (apart from the optional porous support).

Furthermore, in this preferred composition either all of the curable monomers therein are EO-PO monomers or, where the composition comprises more than one curable monomer at least 30 wt % of all curable monomers present in the composition are EO-PO monomers.

The composition of the GSM may be calculated from the amounts and identity of the components used to form it. Where the amounts and identity of the components used to form the GSM are not known, for example the GSM has been obtained from a supplier who refuses to provide this information, one may determine the identity and amounts of components from which the GSM was obtained by analysis of the GSM, e.g. using pyrolysis and gas chromatography. This technique is particularly useful for determining the identity and ratio of monomers used to form the GSM. A suitable pyrolysis and gas chromatography technique which may be used to determine the composition of a GSM is described in the paper by H. Matsubara and H. Ohtani entitled “Rapid and Sensitive Determination of the Conversion of UV-cured Acrylic Ester Resins by Pyrolysis-Gas Chromatography in the Presence of an Organic Alkali” in Analytical Sciences, 2007, 23(5), 513.

Preferably the gas-separation membrane is substantially non-porous. In other words, the membrane comprises pores having an average size (i.e. average pore size) which does not exceed the kinetic diameter of the gas molecules which are desired to be retained by (i.e. not pass through) the membrane.

A suitable method to determine the average pore size of a membrane is to inspect the surface thereof by scanning electron microscope (SEM) e.g. using a Jeol JSM-6335F Field Emission SEM, applying an accelerating voltage of 2 kV, working distance 4 mm, aperture 4, sample coated with Pt with a thickness of 1.5 nm, magnification 100 000×, 3° tilted view.

Preferably the gas-separation membrane has an average pore size of below 10 nm, more preferably below 5 nm, especially below 2 nm. The maximum preferred pore size depends on the application e.g. on the compounds to be separated.

Another method to obtain an indication of the porosity of a membrane is the measure its permeance to a liquid, e.g. water. Preferably the permeance of the gas-separation membrane to liquids is very low, i.e. the average pore size of the gas-separation membrane is such that its pure water permeance at 20° C. is less than 6.10-8 m3/m2·s·kPa, more preferably less than 3.10-8 m2·s·kPa.

In one embodiment the membrane further comprises a porous support. The primary purpose of the porous support is to provide mechanical strength to the membrane without materially reducing gas flux. Therefore the support is typically open-pored (before it is converted into the gas-separation membrane), relative to the polymer formed from curing the EO-PO monomer.

The porous support may be, for example, a microporous organic or inorganic membrane, or a woven or non-woven fabric. The porous support may be constructed from any suitable material. Examples of such materials include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile.

One may use a commercially available porous sheet material as the porous support, if desired. Alternatively one may prepare the porous support using techniques generally known in the art for the preparation of microporous materials.

One may also use a porous support which has been subjected to a corona discharge treatment, glow discharge treatment, flame treatment, ultraviolet light irradiation treatment or the like, e.g. for the purpose of improving its wettability and/or adhesiveness.

The porous support preferably possesses pores which are as large as possible, consistent with providing a smooth surface for the polymer layer (i.e. discriminating layer) formed from curing the EO-PO monomer.

Optionally the porous support comprises a gutter layer. A gutter layer does not discriminate between gases but instead provides a smooth surface for the discriminating layer formed from curing the EO-PO monomer.

The porous support preferably has an average pore size of at least about 50% greater than the average pore size of the discriminating layer (i.e. the polymer layer formed from curing the EO-PO monomer), more preferably at least about 100% greater, especially at least about 200% greater, particularly at least about 1,000% greater than the average pore size of the discriminating layer.

The pores passing through the porous support preferably have an average diameter of 0.001 to 10 μm, more preferably 0.01 to 1 μm. The pores at the surface of the porous support typically have a diameter of 0.001 to 0.1 μm, preferably 0.005 to 0.05 μm. The pore diameter may be determined by, for example, viewing the surface of the porous support before it is converted to the gas-separation membrane by scanning electron microscopy (“SEM”) or by cutting through the support and measuring the diameter of the pores within the support, again by SEM.

The porosity at the surface of the porous support may also be expressed as a % porosity, i.e.

$$\% porosity = 100 \% \times \frac{( area of the surface which is missing due to pores )}{( total surface area )}$$

The areas required for the above calculation may be determined by inspecting the surface of the porous support by SEM. Thus, in a preferred embodiment, the porous support has a % porosity >1%, more preferably >3%, especially >10%, more especially >20%.

The porosity of the porous support may also be expressed as a CO₂ gas permeance (units are m³(STP)/m²·s·kPa). Preferably the support has a CO₂ gas permeance of 5 to 150×10⁻⁵ m³(STP)/m²·s·kPa, more preferably of 5 to 100, most preferably of 7 to 70×10⁻⁵ m³(STP)/m²·s·kPa.

Alternatively the porosity may be characterised by measuring the N₂ gas flow rate through the porous support. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the porous support under test. The N₂ flow rate through the porous support at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant membrane being reduced by the porous support.

The above pore sizes and porosities refer to the porous support before it has been converted into the gas-separation membrane of the present invention.

The porous support preferably has an average thickness of 20 to 500 μm, preferably 50 to 400 μm, especially 100 to 300 μm.

Optionally the porous support comprises a gutter layer. The gutter layer, when present, is in direct contact with the discriminating layer formed from curing the composition comprising the EO-PO monomer.

The gutter layer is permeable to gasses and typically has low or no ability to discriminate between gases. The composition comprising the EO-PO monomer is preferably applied to the gutter layer of the porous support and cured thereon.

The optional gutter layer preferably has an average thickness of 50 to 800 nm, preferably 150 to 700 nm, especially 200 to 650 nm, e.g. 230 to 270 nm, 300 to 360 nm, 380 to 450 nm, 470 to 540 nm or 560 to 630 nm.

Optionally the membrane comprises one or more further ingredients, for example cellulose acetate and/or a polyetherimide.

The discriminating layer formed from curing the composition comprising the EO-PO monomer preferably has an average thickness 5 to 120 nm, preferably 10 to 110 nm, especially 20 to 100 nm i.e. 50, 60, 70, 80 or 90 nm.

In order to form the membrane, one may apply the composition comprising the EO-PO monomer to a support (e.g. a porous or non-porous support) and then cure the composition. When the support is non-porous, the resultant gas-separation membrane may be peeled-off the non-porous support to provide a gas-separation membrane which is free from porous supports. When the composition comprising the EO-PO monomer is applied to a porous support (which optionally comprises a gutter layer) one may allow the composition to permeate into the porous support before curing, thereby providing a strong bond between the polymer formed from the composition and the porous support.

In order to achieve a good adhesion of the discriminating layer (formed from the composition comprising the EO-PO monomer) to the porous support, the composition comprising the EO-PO monomer optionally comprises a component (e.g. a monomer, oligomer and/or polymer) having groups which are reactive with a surface component of the porous support. For example, one of the gutter layer/porous support and the discriminating layer comprises epoxy groups, trialkoxysilyl groups and/or oxetane groups and the other comprises groups which are reactive therewith, e.g. carboxylic acid groups, sulphonic acid groups, hydroxyl groups, and/or thiol groups.

In one embodiment the gas-separation membrane further comprises a protective layer. The protective layer typically performs the function of providing a scratch and crack resistant layer on top of the discriminating layer (formed from the composition comprising the EO-PO monomer) and/or sealing any defects present in the discriminating layer.

The protective layer preferably has an average thickness 500 to 2,000 nm, preferably 750 to 1,800 nm, especially 1,000 to 1,500 nm, more especially 1,100 to 1,300 nm, e.g. 1,150 to 1,250 nm.

The protective layer preferably comprises pores of average diameter <1 nm. The protective layer optionally has surface characteristics which influence the functioning of the gas-separation membrane, for example by making the membrane surface more hydrophilic.

Thus the gutter layer (when present) is present as part of the (optional) porous support, the discriminating layer (formed from the composition comprising the EO-PO monomer) is present on the porous support (when present) and the protective layer, when present, is present on the discriminating layer.

The gutter layer and the protective layer are preferably each independently obtained from curing a curable composition comprising:
(1) 0.5 to 25 wt % of radiation-curable component(s), at least one of which comprises dialkylsiloxane groups;
(2) 0 to 5 wt % of a photo-initiator; and
(3) 70 to 99.5 wt % of inert solvent.

Preferably the curable composition used to prepare the gutter layer and/or protective layer has a molar ratio of metal:silicon of at least 0.0005, more preferably 0.001 to 0.1 and especially 0.003 to 0.03.

The radiation-curable component(s) of component (1) typically comprise at least one radiation-curable group. Radiation curable groups include ethylenically unsaturated groups (e.g. (meth)acrylic groups (e.g. CH₂═CR¹—C(O)— groups), especially (meth)acrylate groups (e.g. CH₂═CR¹—C(O)O— groups), (meth)acrylamide groups (e.g. CH₂═CR¹—C(O)NR¹— groups), wherein each R¹ independently is H or CH₃) and especially oxetane or epoxide groups (e.g. glycidyl and epoxycyclohexyl groups).

The amount of radiation-curable component(s) present in the curable composition used to prepare the gutter layer and/or protective layer (i.e. component (1)) is preferably 1 to 20 wt %, more preferably 2 to 15 wt %. In a preferred embodiment, component (1) of the curable composition used to prepare the gutter layer and/or protective layer comprises a partially crosslinked, radiation-curable polymer comprising dialkylsiloxane groups.

The photo-initiator (2) is independently as hereinbefore described in relation to the composition comprising the EO-PO monomer.

The function of the inert solvent (3) is to provide compositions with a viscosity suitable for the particular method used to apply the curable composition to the support. For high speed application processes one will usually choose an inert solvent of low viscosity. Examples of suitable inert solvents are mentioned above in relation to preparation of the polymer sheet.

The amount of inert solvent (3) present in the curable composition used to prepare the gutter layer and/or protective layer (i.e. component (3)) is preferably 70 to 99.5 wt %, more preferably 80 to 99 wt %, especially 90 to 98 wt %.

Inert solvents are not radiation-curable.

The compositions may contain other components, for example surfactants, surface tension modifiers, viscosity enhancing agents, biocides and/or other components capable of co-polymerisation with the other ingredients.

The thickness of the various layers (e.g. the gutter layer, the discriminating layer and the protective layer) may be determined by cutting through the membrane and examining its cross section by scanning electron microscopy (“SEM”). The part of the gutter layer or discriminating layer which is present within the pores of the porous support is not taken into account.

The gas-separation membrane comprises oxyethylene groups and oxypropylene groups and preferably these groups are distributed randomly in the membrane.

Preferably the membrane comprises more oxyethylene groups than oxypropylene groups, for example at least twice and more preferably from 4 to 5 times as many oxyethylene groups as oxypropylene groups.

The preferred average dry thickness of the gas-separation membrane of the present invention, including the support, is from 0.05 to 10 μm, more preferably between 0.09 and 5 μm and especially from 0.1 to 3 μm. When no support is present the membrane preferably has a thickness of 10 to 100, especially 20 to 50 μm.

The permeability of the gas-separation membrane to gases and vapours depends on the performance of the discriminating layer (formed from the composition comprising the EO-PO monomer). Therefore the membrane preferably is or comprises a thick free film free from defects (e.g. pinholes) because defects reduce selectivity.

The permeance of the gas-separation membrane to gases and vapours is directly related to the thickness of the discriminating layer (formed from the composition comprising the EO-PO monomer), so a thin discriminating layer is preferred. On the other hand the discriminating layer should be uniform without defects such as pinholes that would reduce selectivity. In the case of membranes which are free from porous supports, the membranes are preferably thick (preferably 10 to 100, especially 20 to 50 μm, as described above).

According to a second aspect of the present invention there is provided a process for preparing a gas-separation membrane comprising curing a composition as defined in relation to the first aspect of the present invention.

For gas-separation membranes comprising a porous support, the process preferably comprises the steps a. and b.:
a. applying a composition as defined in relation to the first aspect of the present invention to a porous support; and
b. curing the said composition to form a discriminating layer on and/or in the porous support.

Optionally the process further comprises the step of applying a protective layer to the product of step b.

In a preferred process the composition comprising the EO-PO monomer is applied to a support (i.e. a porous or non-porous support, depending on whether a supported on non-supported gas-separation membrane is required) in a roll-to-roll process having high tension forces at unrolling and/or rolling of at least 50 N/m². In even more preferred process the tension forces of unrolling or rolling are at least 100 N/m².

When the gas-separation membrane comprises several layers (e.g. a gutter layer and/or protective layer in addition to the discriminating layer derived from the composition comprising the EO-PO monomer) conveniently compositions used to form the various layers are applied to a support by a multilayer coating method, for example using a consecutive multilayer coating method.

The various compositions are preferably radiation-curable compositions. Preferably irradiation to cure the composition(s) begins within 7 seconds, more preferably within 5 seconds, most preferably within 3 seconds, of the composition being applied to the support or the discriminating layer, as the case may be.

Suitable sources of UV radiation include mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are UV emitting lamps of the medium or high pressure mercury vapour type. In addition, additives such as metal halides may be present to modify the emission spectrum of the lamp. In most cases lamps with emission maxima between 200 and 450 nm are particularly suitable.

The energy output of the irradiation source is preferably from 20 to 1000 W/cm, preferably from 40 to 500 W/cm but may be higher or lower as long as the desired exposure dose can be realized.

Irradiation in order to cure the compositions may be performed before, during each step of the process. For example, one may apply the first composition to the support and then irradiate the composition to form the gutter layer on the support. One may then apply the second composition to the gutter layer and then form the discriminating by forming a film from the second composition comprising the EO-PO monomer, e.g. by photocuring the second composition. One may then apply the third composition to the discriminating layer and then irradiate the third composition to form the protective layer on the discriminating layer. Alternatively, one may apply the compositions simultaneously to a support in a layer-wise manner and then cure them, e.g. by irradiating and optionally heating and/or drying the coated support to form all layers simultaneously.

In order to produce sufficiently flowable compositions for use in a high speed coating machine, the composition(s) preferably have a viscosity below 4000 mPa s when measured at 25° C., more preferably from 0.4 to 1000 mPa s when measured at 25° C. Most preferably the viscosity of the composition(s) is from 0.4 to 500 mPa·s when measured at 25° C. For coating methods such as slide bead coating the preferred viscosity is from 1 to 100 mPa·s when measured at 25° C. The desired viscosity is preferably achieved by controlling the amount of solvent in the composition(s) and/or by appropriate selection of the components of the composition(s) and their amounts.

With suitable coating techniques, coating speeds of at least 5 m/min, e.g. at least 10 m/min or even higher, such as 15 m/min, 20 m/min, 25 m/min or even up to 100 m/min, can be reached. In a preferred embodiment the composition(s) are applied to a support at the aforementioned coating speeds.

The thickness of the protective layer (when present) may be influenced by controlling the amount of third composition per unit area applied to the discriminating layer. For example, as the amount of third composition per unit area increases, so does the thickness of the resultant protective layer. An analogous principle applies to formation of the discriminating layer and protective layer.

While it is possible to prepare the membranes of the invention on a batch basis with a stationary support, it is much preferred to prepare them on a continuous basis using a moving support, e.g. the support may be in the form of a roll which is unwound continuously or the support may rest on a continuously driven belt. Using such techniques the composition(s) used to form the various layers can be applied on a continuous basis or they can be applied on a large batch basis. Removal of any inert solvent present in the composition(s) can be accomplished at any stage after the composition(s) have been applied to the support, e.g. by evaporation or drying.

Thus in a preferred process for making the gas-separation membranes of the present invention, the compositions are applied continuously to a support by means of a manufacturing unit comprising one or more composition application stations, one or more curing stations and a gas-separation membrane collecting station, wherein the manufacturing unit comprises a means for moving the support from the first to the last station (e.g. a set of motor driven pass rollers guiding the support through the coating line). The manufacturing unit optionally comprises one composition application station which applies the first, second and third curable compositions, e.g. a slide bead coater. The unit optionally further comprises one or more drying stations, e.g. for forming the discriminating layer and/or drying the final gas-separation membrane.

Preferably the process further comprises the step of activating the gutter layer (when present) using a corona treatment (e.g. atmospheric or vacuum), a plasma treatment, flame treatment and/or ozone treatment. For the corona or plasma treatments, generally an energy dose of 0.5 to 100 kJ/m² is sufficient, for example about 1, 3, 5, 8, 15, 25, 45, 60, 70 or 90 kJ/m².

The gutter layer (preferably comprising dialkylsiloxane groups) preferably performs the function of providing a smooth and continuous surface as a foundation for the discriminating layer.

If desired, one may prevent the composition used to form the gutter layer or discriminating layer from permeating too deeply into a porous support by any of a number of techniques. For example, one may select a composition which has a sufficiently high viscosity to make such permeation unlikely. With this in mind, the composition used to form the gutter layer or discriminating layer preferably has a viscosity of 0.1 to 500 Pa·s at 25° C., more preferably 0.1 to 100 Pa·s at 25° C. Alternatively, the process optionally comprises the step of filling the pores of the porous support with an inert (i.e. non-curable) liquid before applying the curable composition used to form the gutter layer or discriminating layer. This technique has an advantage over the first technique mentioned above in that one may form thinner membranes and more application techniques are available for compositions of lower viscosity.

The gas-separation membrane is preferably in tubular or, more preferably, in sheet form. Tubular forms of membrane are sometimes referred to as being of the hollow fibre type. Membranes in sheet form are suitable for use in, for example, spiral-wound, plate-and-frame and envelope cartridges.

Optionally the gas-separation membrane comprises layers in addition to the discriminating layer. Such additional layers may be applied using analogous techniques disclosed herein for the optional gutter layer, discriminating layer and optional protective layer.

While this specification emphasises the usefulness of the membranes of the present invention for separating gases, especially polar and non-polar gases, it will be understood that the membranes can also be used for other purposes, for example providing a reducing gas for the direct reduction of iron ore in the steel production industry, dehydration of organic solvents (e.g. ethanol dehydration), pervaporation, oxygen enrichment, solvent resistant nanofiltration and vapour separation.

The gas-separation membranes are particularly suitable for separating a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the membranes have a high permeability to polar gases, e.g. CO₂, H₂S, NH₃, SOₓ, and nitrogen oxides, especially NOₓ, relative to non-polar gases, e.g. alkanes, H₂, N₂, and water vapour.

The target gas may be, for example, a gas which has value to the user of the membrane and which the user wishes to collect. Alternatively the target gas may be an undesirable gas, e.g. a pollutant or ‘greenhouse gas’, which the user wishes to separate from a gas stream in order to meet product specification or to protect the environment.

Preferably the gas-separation membrane has a H₂S/CH₄ selectivity (αH₂S/CH₄) ≥30. Preferably the selectivity is determined by a process comprising exposing the membrane to a CO₂/CH₄/nC₄H₁₀/H₂S=77/22/0.7/0.3 (amounts by volume) of H₂S and CH₄ respectively at a feed pressure of 6000 kPa at 40° C.

Preferably the gas-separation membrane has a permeability to H₂S of at least 300 Barrer. Preferably the gas-separation membrane has a permeability to CH₄ of at most 10 Barrer. The permeability may be measured by the method described below.

Preferably the gas-separation membrane is gas permeable and liquid impermeable.

According to a third aspect of the present invention there is provided a process for separating a feed gas comprising polar and non-polar gases into a gas stream rich in polar gases and a gas stream depleted in polar gases comprising bringing the feed gas into contact with a gas-separation membrane according to the first aspect of the present invention.

Thus in one embodiment the fourth aspect of the present invention the gas-separation membrane comprises a porous support. In another embodiment the fourth aspect of the present invention the gas-separation membrane is free from porous supports.

Thus the gas-separation membranes of the present invention may be used for the separation of gases and/or for the purification of a gas

According to a fourth aspect of the present invention there is provided a gas-separation module comprising a gas-separation membrane according to the first aspect of the present invention.

In the modules of the fourth aspect of the present invention the gas-separation membrane is preferably a flat sheet, a spiral-wound membrane or a hollow-fibre membrane.

The invention will now be illustrated by the following non-limiting Examples in which all parts are by weight unless specified otherwise.

The following materials were used in the Examples (all without further purification):

The following materials were used to prepare the Membranes described below:
HMPP is 2-hydroxy-2-methyl-1-phenyl-1-propanone initiator from Cytec Surface Specialties.
EtAc Is ethyl acetate (a solvent from Aldrich).
A-1000PER is NK ECONOMER™ A-1000PER from Shin-Nakamura Chemical Co., Ltd. of Formula (1) shown above in which L is a divalent organic linking group comprising a random distribution of four oxypropylene groups and seventeen oxyethylene groups.
A-3000PER is NK ECONOMER™ A-3000PER from Shin-Nakamura Chemical Co., Ltd. of Formula (1) shown above in which L is a divalent organic linking group comprising a random distribution of thirteen oxypropylene groups and fifty one oxyethylene groups.
PEG600DA is a monomer comprising two polymerisable groups and is free from oxypropylene groups. PEG600DA was obtained from Sigma Aldrich and has the following structure:

C₂=CH═CO—O—(CH₂—CH₂—O)ₙ—OC—CH═CH₂
n=14
ABPE30 is a monomer comprising two polymerisable groups and is free from oxypropylene groups. A-BPE30 was obtained from Shin-Nakamura Chemical Co., Ltd. and has the following structure:

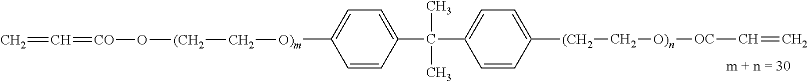

GMT-L-14 is a porous support (a polyacrylonitrile ultrafiltration membrane from GMT and GMT-Membrantechnik GmbH, Germany).
PPG700DA is a monomer comprising two polymerisable groups, twelve oxypropylene groups and no oxyethylene groups. PPG700DA was obtained from sigma Aldrich and has the following structure:

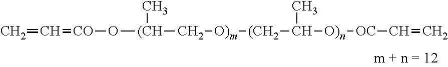

### Performance Tests:

The gas selectivity and permeability of each gas-separation membranes under test were measured using a feed gas having the composition CO₂/CH₄/nC₄H₁₀/H₂S=77/22/0.7/0.3 (by volume). The feed gas was passed through each gas-separation membrane under test at a temperature of 25° C. and feed pressure of 4000 kPa using a circular gas permeation cell having a measurement diameter of 1.5 cm. The flow rate, pressure, and gas composition of each feed gas, permeate gas, and retentate gas was calculated according formulation described in “Calculation Methods for Multicomponent Gas Separation by Permeation” (Y. Shindo et al, Separation Science and Technology, Vol. 20, Iss. 5-6, 1985) with “countercurrent flow” mode.

### Permeability

The permeability (Pi) shown in Table 1 was measured as follows:

The permeability (Pi) of CO₂, H₂S, CH₄ and nC₄H₁₀ was determined using the following equation:

Pi=(θ_{Perm}·X_{Perm,i})/(A·(P_{Feed}·X_{Feed,i}−P_{Perm}·X_{Perm,i}))
For example:

P(H2S)=(θ_{Perm}·X_{Perm,H2S})/(A·(P_{Feed}·X_{Feed,H2S}−P_{Perm}·X_{Perm,H2S}))

P(CH4)=(θ_{Perm}·X_{Perm,CH4})/(A·(P_{Feed}·X_{Feed,CH4}−P_{Perm}·X_{Perm,CH4}))

α(H2S/CH4)=P(H2S)/P(CH4)

wherein:
Pi=Permeability of the relevant gas (i.e. is CO₂, H₂S, CH₄ or nC₄H₁₀) (m³(STP)·m/m²·kPa·s);
θ_{Perm}=Permeate flow rate (m³(STP)/s);
X_{perm,i}=Volume fraction of the relevant gas in the permeate gas;
A=Membrane area (m²);
P_{Feed}=Feed gas pressure (kPa);
X_{Feed,i}=Volume fraction of the relevant gas in the feed gas;
P_{Perm}=Permeate gas pressure (kPa); and
STP is standard temperature and pressure, which is defined here as 25.0° C. and 1 atmosphere pressure (101.325 kPa).

The Barrer (P) was then determined by 1 Barrer=1×10⁻¹⁰ cm³(STP)·cm/(s·cm²·cmHg).

### Selectivity

The selectivity (Sel) shown in Table 1 was measured as follows:

The membrane patch selectivity (H₂S/CH₄ selectivity; α(H₂S/CH₄)) of the membrane under test for the gas mixture described in Table 2 was calculated from respectively from P_{(H2S)} and P_{(CH4)} calculated as described in (A) above based on following equations:

H₂S/CH₄ selectivity: α(H₂S/CH₄)═P_{(H2S)}/P_{(CH4)}

The permeance (Q) shown in Table C was measured as follows:

The permeance (Qi) of CO₂, H₂S, CH₄ and nC₄H₁₀ was determined using the following equation:

Qi=Pi·L
Qi=Permeance of the relevant gas (i is CO₂, H₂S, CH₄ or nC₄H₁₀) (m³(STP)/m²·kPa·s);
L=Thickness of discrimination layer in membrane [μm]
   The Barrer (Q) was then determined by 1 GPU=1×10⁻⁶ cm³(STP)/(s·cm²·cmHg).

### EXAMPLES

### (a) Preparation of Compositions and Comparative Compositions

Compositions C1 to C5 and comparative compositions CC1 to CC6 were prepared by mixing the ingredients shown in Table A below at 40° C.:

TABLE A

| | EO-PO | Other | Wt % EO-PO monomer | | |
|---|---|---|---|---|---|
| | Monomer | monomer (s) | relative to all | Initiator | Solvent |
| Composition | (parts) | (parts) | curable monomers | (parts) | (parts) |
| C1 | A-1000PER (49) | — | 100 | HMPP (1) | EtAc (50) |
| C2 | A-1000PER (24.5) | PEG600DA (24.5) | 50 | HMPP (1) | EtAc (50) |
| C3 | A-1000PER (24.5) | ABPE30 (24.5) | 50 | HMPP (1) | EtAc (50) |
| C4 | A-3000PER (49) | — | 100 | HMPP (1) | EtAc (50) |
| C5 | A-3000PER (24.5) | PEG600DA (24.5) | 50 | HMPP (1) | EtAc (50) |
| CC1 (Comparative) | — | PEG600DA (49) | 0 | HMPP (1) | EtAc (50) |
| CC2 (Comparative) | — | PPG700DA (49) | 0 | HMPP (1) | EtAc (50) |
| CC3 (Comparative) | — | PPG700DA (9.8) | 0 | HMPP (1) | EtAc (50) |
| | | PEG600DA (39.2) | | | |
| CC4 (Comparative) | — | PPG700DA (24.5) | 0 | HMPP (1) | EtAc (50) |
| | | PEG600DA (24.5) | | | |
| CC5 (Comparative) | — | ABPE30 (49) | 0 | HMPP (1) | EtAc (50) |
| CC6 (Comparative) | A-1000PER (10) | PEG600DA (39) | 20.4 | HMPP (1) | EtAc (50) |

Note:
In CC6 the curable monomers comprise < 30 wt % EO-PO monomer

### (b) Preparation of Gas-Separation Membranes

Membranes M1 to M5 and Comparative Membranes CM1 to CM6 were prepared by coating each of the compositions C1 to C6 and CC1 to CC5 respectively onto a non-porous support (Toretec™ from Toray, a polyethylene sheet of thickness 50 μm) using a block coater (Film applicator, 75 μm gap, from supplier BVES). Each resultant layer of composition had a thickness of 75 μm and was dried for 30 minutes at 40° C. and then cured by exposure to UV light using a Light-Hammer™ UV lamp fitted in a bench-top conveyor LC6E (both supplied by Fusion UV Systems) set at 100% UV power (D-bulb) and moving the polyethylene sheets carrying the composition under the UV lamp at a speed of 15 m/minutes. The resultant polymer sheets derived from curing the compositions was removed from the polyethylene plate to give membranes M1 to M5 according to the invention (when using compositions C1 to C5) and comparative membranes CM1 to CM6 (when using comparative compositions CC1 to CC6). The gas-separation membranes in these examples were all free from porous supports. In each case the resultant gas-separation membrane had a dry thickness of 30 μm.

### (c) Testing of the Gas-Separation Membranes

The membranes obtained in step (b) (M1 to M5 according to the invention and comparative membranes CM1 to CM6) were tested using the methods described above to determine their H₂S permeability (P(H₂S)) and their H₂S/CH₄ selectivity (α(H₂S/CH₄)). The results are shown in Table B below. A H₂S permeability (P(H₂S)) above 300 Barrer was deemed to be good. A H₂S/CH₄ selectivity (α(H₂S/CH₄)) from 30 was deemed to be good.

From Table B it can be seen that the membranes according to the present invention have good H₂S permeability (>300 barrer) and H₂S/CH₄ selectivity (30).

TABLE B
Results

| | | Results | |
|---|---|---|---|
| | | P | α |
| Composition | Membrane | (H₂S) (Barrer) | (H₂S/CH₄) |
| C1 | M1 | 588 | 31 |
| C2 | M2 | 485 | 45 |
| C3 | M3 | 510 | 35 |
| C4 | M4 | 601 | 30 |
| C5 | M5 | 535 | 41 |
| CC1 (Comparative) | CM1 (Comparative) | 160 | 52 |
| CC2 (Comparative) | CM2 (Comparative) | 290 | 15 |
| CC3 (Comparative) | CM3 (Comparative) | 190 | 33 |
| CC4 (Comparative) | CM4 (Comparative) | 240 | 25 |
| CC5 (Comparative) | CM5 (Comparative) | 259 | 19 |
| CC6 (Comparative) | CM6 (Comparative) | 180 | 49 |

### Examples 6 to 8 and Comparative Example 7

### (a) Preparation of Compositions and Comparative Compositions

Compositions C6 to C8 and comparative composition CC7 were prepared by mixing the ingredients shown in Table A below at 40° C.:

TABLE C

| | EO-PO | Other | Wt % EO-PO monomer | | |
|---|---|---|---|---|---|
| | Monomer | monomer (s) | relative to all | Initiator | Solvent |
| Composition | (parts) | (parts) | curable monomers | (parts) | (parts) |
| C6 | A-1000PER (10) | — | 100 | HMPP (0.1) | EtAc (89.9) |
| C7 | A-1000PER (50) | PEG600DA (5) | 90.9 | HMPP (0.1) | EtAc (89.9) |
| C8 | A-1000PER (50) | ABPE30 (5) | 90.9 | HMPP (0.1) | EtAc (89.9) |
| CC7 | — | ABPE30 (10) | 0 | HMPP (0.1) | EtAc (89.9) |

### (b) Preparation of Gas-Separation Membranes

Membranes M6 to M8 and Comparative Membrane CM7 were prepared by coating each of the compositions C6 to C8 and CC7 respectively continuously and at 30° C. onto a porous support (GMT-L14) using just one slot of a slide bead coating machine. The resultant, coated porous support passed was cured by passing it under an irradiation source (a Light Hammer LH6 from Fusion UV Systems fitted with a D-bulb working at 100% intensity) and then to a drying zone at 40° C. and 8% relative humidity. The resultant dried, gas-separation membrane then travelled to the collecting station. A section through the resultant composite membranes was examined by a scanning electron microscope (SEM) and the coating layer in each case was found to have a thickness of 2.5 μm.

### (c) Testing of the Gas-Separation Membranes

The membranes obtained in step (b) (M6 to M8 according to the invention and comparative membrane CM7) were tested using the methods described above to determine their H₂S permeance Q(H₂S) and their H₂S/CH₄ selectivity (α(H₂S/CH₄). The results are shown in Table D below. A H₂S permeance (Q(H₂S)) above 150 GPU was deemed to be good. A α(H₂S/CH₄) from 30 was deemed to be good.

From Table C it can be seen that the membranes according to the present invention have good H₂S permeance (>150 GPU) and H₂S/CH₄ selectivity (≥30).

TABLE D
Results

| | | Results | |
|---|---|---|---|
| | | Q | α |
| Composition | Membrane | (H₂S) (GPU) | (H₂S/CH₄) |
| C6 | M6 | 230 | 31 |
| C7 | M7 | 184 | 45 |
| C8 | M8 | 202 | 35 |
| CC7 (Comparative) | CM7 (Comparative) | 98 | 18 |

1-24. (canceled)

25. A gas-separation membrane obtainable from curing a composition comprising at least 30 wt % one or more curable monomer(s) comprising oxyethylene groups, oxypropylene groups and at least two polymerizable groups relative to the total amount of used curable monomers in the composition wherein the polymerizable groups are each independently selected from (meth)acrylic groups and vinyl groups.

26. A gas-separation membrane according to claim 25 wherein all of the curable monomers present in the composition comprise oxyethylene groups, oxypropylene groups and at least two polymerizable groups.

27. A gas-separation membrane obtainable from curing a composition comprising at least 50 wt % one or more curable monomer(s) comprising oxyethylene groups, oxypropylene groups and at least two polymerizable groups relative to the total amount of used curable monomers in the composition wherein the polymerizable groups are each independently selected from (meth)acrylic groups and vinyl groups.

28. A gas-separation membrane according to claim 25 wherein the monomer comprising oxyethylene groups, oxypropylene groups and at least two polymerizable groups is of Formula (1):
H2C═CH—CO2-L-CO—CH═CH2 Formula (1)
wherein L is a divalent organic linking group comprising oxypropylene groups and oxyethylene groups.

29. A gas-separation membrane according to claim 25 wherein the oxyethylene groups and the oxypropylene groups are distributed randomly in the monomer.

30. A gas-separation membrane according to claim 27 wherein the number of oxyethylene groups in the monomer is greater than the number of oxypropylene groups in the monomer.

31. A gas-separation membrane according to claim 25 wherein the number of oxyethylene groups in the monomer is a factor of 4 to 5 times the number of oxypropylene groups in the monomer.

32. A gas-separation membrane according to claim 25 wherein the monomer has a NAMW of 500 to 5,000.

33. A gas-separation membrane according to claim 25 wherein the composition comprises a further monomer, said further monomer comprising at least one polymerizable group and being free from oxypropylene groups.

34. A gas-separation membrane according to claim 33 wherein the further monomer comprises oxyethylene groups.

35. A gas-separation membrane according to claim 27 wherein the polymerizable groups are acrylate groups.

36. A gas-separation membrane according to claim 28 wherein the divalent organic linking group represented by L comprises 4 to 20 of the oxypropylene groups and 10 to 60 of the oxyethylene groups

37. A gas-separation membrane according to claim 28 the oxypropylene groups and the oxyethylene groups are distributed randomly in the divalent organic linking group represented by L.

38. A gas-separation membrane according to claim 25 wherein:
(a) the oxypropylene groups are of the formula —CH₂CH(CH₃)O—; and
(b) the oxyethylene groups are of the formula —CH₂CH₂O—.

39. A gas-separation membrane according to claim 25 which has a H₂S/CH₄ selectivity (α(H₂S/CH₄)) of at least 30 and a permeability to H₂S of at least 300 Barrer.

40. A gas-separation membrane according to claim 25 which further comprises a porous support.

41. A gas-separation membrane according to claim 27 which has a H₂S/CH₄ selectivity (α(H₂S/CH₄)) of at least 30 and a permeance to H₂S of at least 150 GPU.

42. A process for preparing a gas-separation membrane comprising curing a composition as defined in claim 25.

43. A process for separating a feed gas comprising polar and non-polar gases into a gas stream rich in polar gases and a gas stream depleted in polar gases comprising bringing the feed gas into contact with a membrane according to claim 25.

44. A gas separation module comprising a gas-separation membrane according to claim 25.
